(19) United States
(12) Patent Application Publication
(10) Pub. No.: US 2011/0033588 A1
(43) Pub. Date: Feb. 10, 2011

(54) System and method for dispensing oil for popping popcorn

(76) Inventor: William D. Brush, North Loup, NE (US)

Correspondence Address: PHILIP J LEE, 10050 REGENCY CIRCLE, SUITE 525, OMAHA, NE, 68114, US

(21) Appl. No.: 12/803,408

(22) Filed: Jun. 25, 2010

Related U.S. Application Data
(60) Provisional application No. 61/269,530, filed on Jun. 25, 2009.

(51) Int. Cl. A47J 47/01; A23L 1/18

(52) U.S. Cl. 426/233; 99/323.7

(57) ABSTRACT

A system and method for dispensing a desired volume of popcorn popping oil into the kettle of a popcorn popper assembles a container of oil raised above the kettle with a flexible tube leading from the container to a point just above the kettle and the placement of two normally closed valves along the tubing forming a chamber within the tube between the two valves with a volume determined by the separation of the valves and the volume of the tube chamber is the volume of oil to be dispensed and the system is operated by opening the upper valve closest to the oil container, closing the upper valve after the tube chamber fills with oil, and then opening the lower valve allowing the oil to flow from the tube chamber into the popping kettle.

### CROSS REFERENCE TO RELATED PROVISIONAL APPLICATION

This application claims the benefit of U.S. Provisional Application No. 61/269,530, filed Jun. 25, 2009.

### BACKGROUND OF THE INVENTION

A. Field of Invention

The present invention relates generally to systems and methods used in dispensing oil for the process of popping popcorn and more particularly to a new and improved system and method for dispensing popcorn popping oil from a container into a popping kettle.

B. Description of Related Art

In the popping of popcorn in significant quantities, in excess of the capacity of microwave ovens, a quantity of oil is combined with the unpopped corn in a kettle in which the corn and oil are heated to pop the corn. Conventional poppers for commercial use or of greater capacity than home use poppers comprise a main chamber within which a heated kettle is suspended such that popped corn flows over the kettle edge and drops to the floor of the chamber. Kettle popped popcorn requires the introduction of a proper amount of popcorn into the kettle with an appropriate amount of oil. Premeasured packages of popcorn and oil in the desired proportion are sold as “portion packs” for the convenience of the operator. Alternatively, bulk popcorn can be measured and combined with either a measured appropriate amount of oil, often the system used in small capacity poppers, or an appropriate amount of oil can be metered and pumped into the kettle from a supply container. Pumping oil from a large container requires a substantial apparatus and may be appropriate for large capacity poppers, but expensive for an intermediate use situation. On the other hand, measuring oil by hand in a commercial or retail environment can cause an unattractive and messy spilling of oil.

It would therefore be desirable to provide a device and method of dispensing oil into a popcorn popper kettle that is inexpensive to manufacture and use and is capable of reliably charging the kettle with an appropriate amount of oil.

### SUMMARY OF THE INVENTION

The system of the present invention constitutes a supply of edible oil in a container that is adapted to be placed atop or hung on the side of the main chamber of a conventional popper in a position above the kettle. The oil container is further adapted with a port located at or near the bottom of the container for connecting a tubular conduit that extends to the popper kettle. Between the kettle end of the conduit and the oil container, a metering device is interposed so as to allow the metering of the flow of oil from the container to the kettle to allow the flow of a predetermined amount of oil to the kettle. The oil container can be vented at the top to relieve any negative pressure within the container in the event a rigid or stiff container is used, or a flexible walled, “bag” type, container can be used from which the oil is free to flow by the force of gravity. The metering device may be one of a variety of types provided it can be set to allow flow of a predetermined amount of oil. A preferred embodiment consists of a simple metering system comprising two appropriately spaced clamp or pinch type valves that are normally closed placed in series along the tubing and spaced such that the interior volume of the tube between the valves is the volume of oil to be dispensed. A rack for supporting the valves and setting the separation thereof is secured to the main chamber of the popper. Alternative metering devices may include a timed or metered flow control valve or a chamber of predetermined internal volume with valved inlet and outlet ports. Additionally, the oil container may have multiple outlet ports to accommodate different placements, such as either placement atop the popper main chamber or hung on the wall of the chamber.

The method of dispensing a predetermined volume of oil into the popper kettle comprises connecting the oil conduit to the outlet port of the oil container, placing the oil container in a location above the kettle, and securing the kettle end of the conduit suitably above the kettle and below the oil container, and operating the metering device as appropriate. In the case of the preferred embodiment, the method comprises mounting the valve supporting rack on the side of a popper main chamber, placing two normally closed pinch valves in the rack at the desired separation according to the volume of oil to be dispensed, installing the oil conduit by opening the top valve and threading the oil conduit through the top valve while the valve is open and then releasing the valve, which then closes on the oil conduit, and repeating this process to thread the oil conduit through the lower valve to a position appropriate for the flow of oil into the kettle, and then connecting the upper end of the oil conduit to the container of oil. Once the system is in place and installed, the system is operated by opening the top valve to fill the intervening tube chamber, and then releasing the top valve to close the oil conduit, and then opening the bottom valve to dispense the appropriate amount of oil into the kettle. After the desired volume of oil has been dispensed, the bottom valve is released, thereby closing the oil conduit and the top valve is opened to allow oil from the oil container to fill the oil conduit chamber between the two valves. When the oil container is empty, it and the oil conduit may be discarded and replaced.

The principle aim of the present invention is to provide a new and improved method and device for dispensing a predetermined amount of oil into the kettle of a popcorn popper that meets the foregoing requirements being not dependent on electrical power for heat or pumping and being capable of accurately controlling the portion of oil used in the popcorn popping process, and is convenient to operate as well as economical to manufacture and use.

Other objects and advantages of the invention will become apparent from the Description of the Preferred Embodiment and the Drawings and will be in part pointed out in more detail hereinafter.

The invention consists in the features of construction, combination of elements and arrangement of parts exemplified in the construction hereinafter described and the scope of the invention will be indicated in the appended claims.

### BRIEF DESCRIPTION OF THE DRAWINGS

FIG. 1 is a side view of an oil dispensing system in accord with the present invention.

FIG. 2 is a rear view of an oil dispensing system in accord with the present invention.

FIG. 3 is a side view of a pinch valve used in an oil dispensing system in accord with the present invention, shown in its normally closed position.

FIG. 4 is a side view of a pinch valve used in an oil dispensing system in accord with the present invention, shown in an open position.

FIG. 5 is a top view of a pinch valve used in an oil dispensing system in accord with the present invention, shown in its normally closed position.

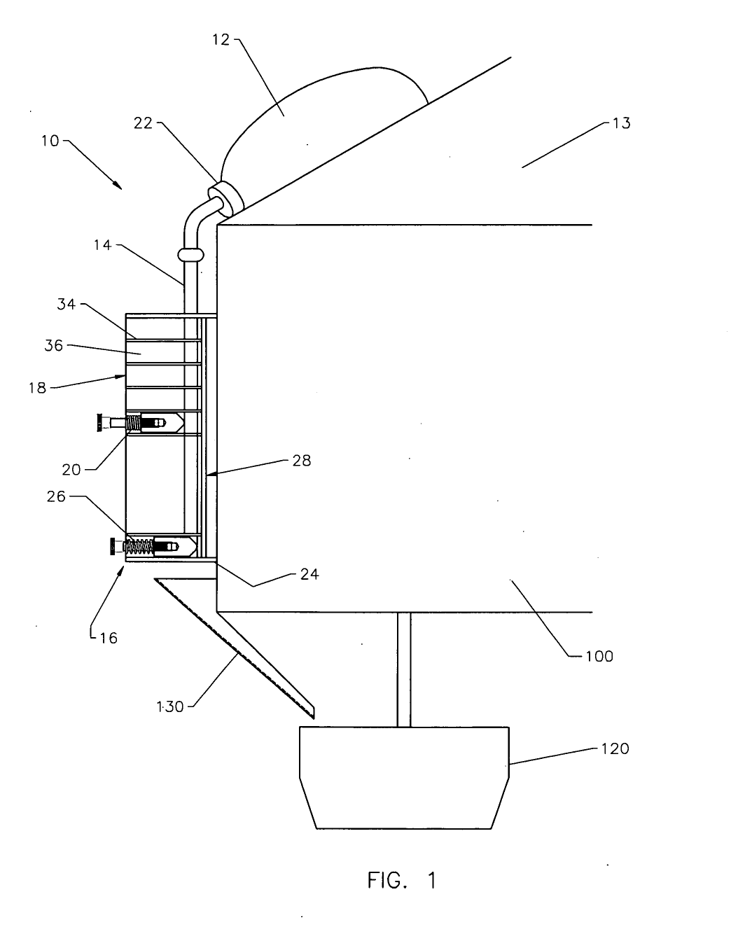

FIG. 1 is a top view of a pinch valve used in an oil dispensing system in accord with the present invention, shown in an open position.

### DESCRIPTION OF THE PREFERRED EMBODIMENT(S)

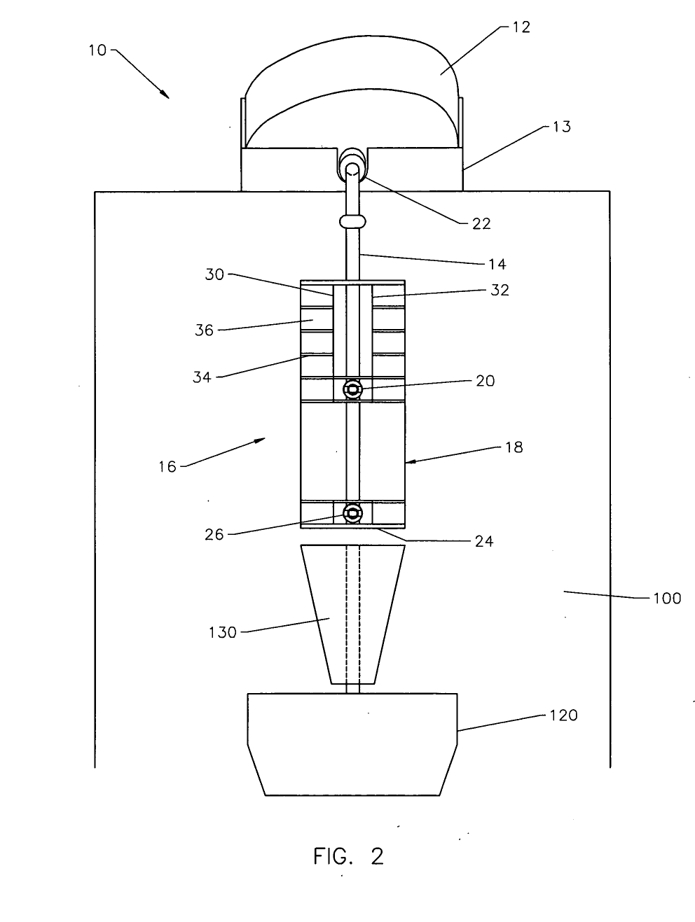

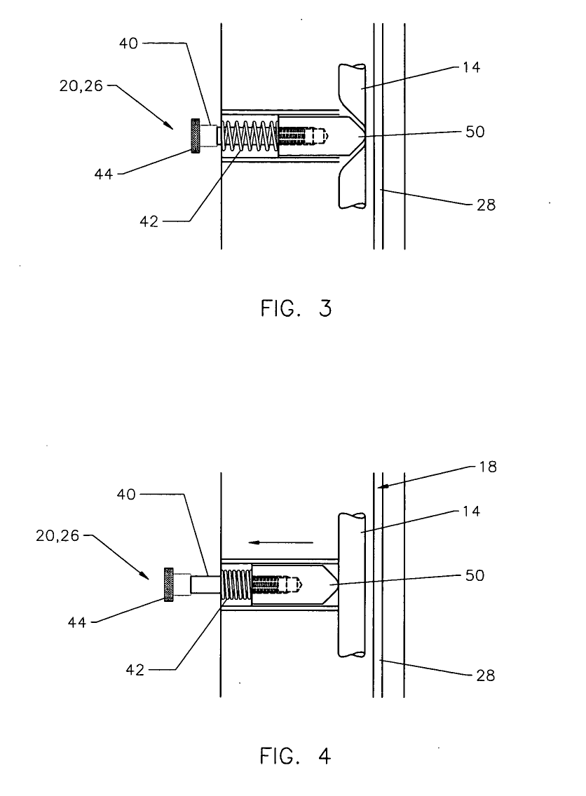

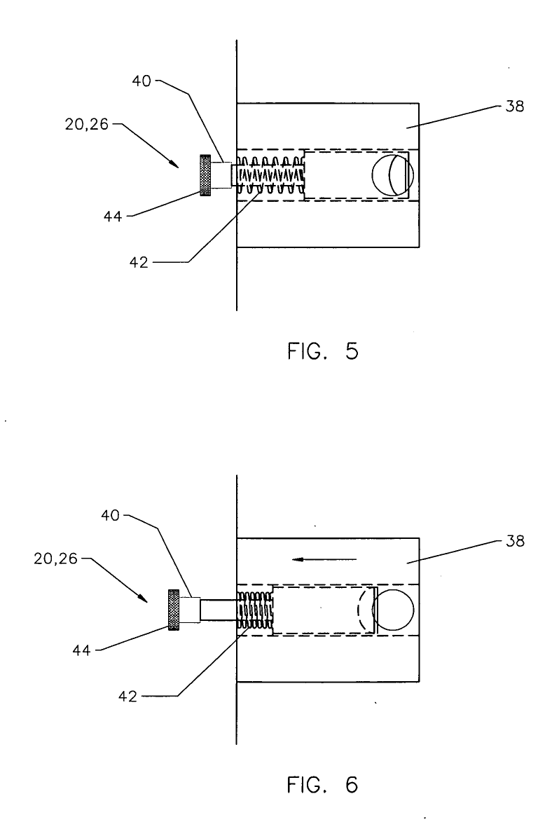

With reference to the Drawings wherein like numerals represent like parts throughout the Figures, a system of the present invention for dispensing measured quantities of oil into a popcorn popper kettle is generally designated by numeral 10 in FIGS. 1 and 2. System 10 is designed for use with a conventional commercial popcorn popper (not completely shown). The common parts of a conventional popper that are relevant are a main enclosed chamber 100 and a heated kettle 120 that is supported within the main chamber above the floor thereof and below the top thereof. Chamber 100 and kettle 120 are partially shown in FIGS. 1 and 2 as stylized examples and the features shown are not a limitation of the applicability of the invention.

System 10 comprises an oil supply container 12, a tubular conduit 14 and a flow control device 16. The oil supply container 12 is constructed of food grade materials so as to provide a sanitary means of storing edible oil suitable for popping popcorn. Since system 10 does not include a heating element, oil used in the operation of system 10 must be liquid at room temperature. Container 12 is shown as a bag of irregular shape supported by a partial support bin 13, but the invention is not limited to such shape or style. Specifically, container 12 may have relatively rigid walls or a combination, such as is referred to as a bag within a box. The oil must flow from oil container 12 by force of gravity for use in the preferred method and therefore must be exposed to the ambient air pressure by means of either a vent or by use of a flexible bag. Oil container 12 is shown installed on top of the main chamber 100 of a conventional popper, and it will be anticipated that oil container 12 could alternatively be hung on the side of the main chamber 100 of a popper and clips, brackets or other simple securing devices (not shown) will be used and container 12 could be adapted to permit the use of such securing devices. Oil supply container 12 is further adapted with a port 22 located at or near the bottom of container 12 for connecting tubular conduit 14. It is anticipated that use of a temporary seal at port 22 will be used to seal port 22 until the end of oil conduit 14 is inserted therein and that the end of conduit 14 is to be adapted for the purpose of piercing the temporary seal of port 22 to allow flow of oil from container 12 through conduit 14. Oil conduit 14 is of sufficient length to extend from container 12 above the kettle 120 to a dispensing end 24 secured above a funnel 130 positioned to direct the flow of oil into the popper kettle 120. The internal diameter of conduit 14 is ample to allow flow of the oil to be used at a relatively rapid rate and is preferably formed of durable and flexible tubing both for ease of installation and to be closable by pinch valves. It will be anticipated that conduit 14 could in the alternative comprise two or more sections as might be desired in the event a non disposable version of conduit 14 is desired or in the event of the use of an alternative configuration of flow control device 16 is used. Flow control device 16 is installed along the oil flow path between conduit dispensing end 24 and oil supply container outlet port 22 to allow the metering of the flow of oil through conduit 14 from oil supply container 12 to kettle 120. The preferred embodiment of flow control device 16 comprises two pinch type valves 20 and 26 installed in a rack 18 by being vertically stacked therein. Rack 18 comprises a back wall 28 that provides support and is secured to the wall of main chamber 100 of a popper. Two side members 30 and 32 extend outwardly from rack back 28 and form partial, opposing shelves 34 vertically arrayed on the inside, facing surfaces of members 30 and 32 such that a series of slots 36 are formed that are open at top and bottom. Each valve 20 and 26 comprised a body 38 in the shape of a rectangular prism having openings at top and bottom and a plunger 40 that is biased toward rack back 28 by a spring 42 compressed between an outer wall of the valve body and a stop formed on plunger 40. A handle end 44 of plunger 40 is shaped to be easily gripped by the operator and the other end of plunger 40 comprises a blunt chisel shaped blade end 50 that is normally biased against the rack back 28. The valves 20 and 26 comprise a passage from top to bottom through which oil conduit passes, past plunger 40, such that plunger 40 normally is biased against conduit 14, which is pinched or clamped between plunger 40 and the rack back 28. Valves 20 and 26 are thus normally closed and may be opened by the operator pulling plunger 40 away from engagement with conduit 14. Each valve body 38 is sized and shaped to be snuggly received within one of the slots 36 and is preferably releasably retained therein by means of a flexible tang or other conventional detent device (not shown). The bottom valve 26 is inserted into the bottom slot 36 and top valve 20 is inserted into one of the upper slots 36. The vertical separation of valves 20 and 26 will depend on the volume of oil to be dispensed.

In the assembled system 10, an oil container is placed in the bin 13, which has been secured to the top of the popper, and valve rack 18 is secured to the wall of the main popper chamber 100. Each time a fresh or full oil container 12 is installed a new oil conduit 14 may be used and is installed by opening top valve 20 and threading conduit 14 through valve 20, bottom valve 26 is then opened and conduit 14 threaded through valve 26 to a point above the kettle funnel 130. It will be anticipated that oil supply container 12 may comprise multiple outlet ports to accommodate alternative installation positions, such as either placement atop the popper main chamber or hung on the wall of the chamber 100.

The method of the present invention for dispensing a predetermined volume of oil into a popper kettle comprises assembling system 10 as described above with the placement of valves 20 and 26 depending upon the volume of oil to be dispensed. The operation of system 10 comprises allowing the chamber within the section of oil conduit 14 that extends between valves 20 and 26 to fill with oil by opening top valve 20, releasing top valve 20 thereby closing it, and then opening bottom valve 26. These steps are repeated as desired until oil container 12 is empty.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention. It is specifically anticipated a variety of materials could be suitable for use in constructing system 10 without departing from the spirit of this invention.

It will be further anticipated that system 10 can and will be dimensioned and configured in a variety of sizes to accommodate a variety of popcorn poppers and kettles.

I claim:

1. A popcorn oil dispensing system comprising a container of oil, flexible tubing having a first end and a second end connected to the oil container and at least one valve positioned between the first and second tubing ends for controlling the flow of oil from the container and through the tubing to the tubing first end.

2. The popcorn oil dispensing system of claim 1 further comprising means for securing the oil container to a popcorn popper having a kettle for popping popcorn.

3. The popcorn oil dispensing system of claim 2, wherein the oil container securing means further comprises means for supporting the oil container in a position above the kettle with the first tubing end connected to the kettle.

4. The popcorn oil dispensing system of claim 3, further comprising a first flow control valve and a second flow control valve and wherein both flow control valves are positioned in series between the first and second tubing ends, forming a chamber within the tubing between the valves.

5. The popcorn oil dispensing system of claim 4, wherein the first and second valves are positioned to cause the volume of the chamber to equal a predetermined volume equal to the volume of oil to be dispensed.

6. The popcorn oil dispensing system of claim 5, further comprising a means for supporting the valves at a variety of separations.

7. A method of measuring and dispensing popcorn popping oil into a kettle in a popcorn popper comprising connecting a flexible tube to an oil container, placing the oil container in a location above the kettle, placing a lower, normally closed flow control valve along the tube, placing an upper, normally closed flow control valve along the tube between the oil container and the lower valve, opening the upper valve until the tube between the valves fills with oil, closing the upper valve, and opening the lower valve until the oil within the tube between the valves flows out of the tube.

8. The method of claim 7, further comprising mounting a valve supporting rack on the popcorn popper, and placing the two valves in the rack at a separation sufficient to create a chamber within the tube between the valves equal to the volume of oil to be dispensed.
